(19) United States
(12) Patent Application Publication
(10) Pub. No.: US 2012/0246181 A1
(43) Pub. Date: Sep. 27, 2012

(54) METHOD FOR CONSTRUCTION AND USE OF A PROBABILISTIC ATLAS FOR DIAGNOSIS AND PREDICTION OF A MEDICAL OUTCOME

(76) Inventors: Wieslaw Lucjan Nowinski, Singapore (SG); Varsha Gupta, Singapore (SG)

(21) Appl. No.: 13/512,322

(22) PCT Filed: Nov. 23, 2010
(86) PCT No.: PCT/SG2010/000442

§ 371 Date: May 25, 2012

(30) Foreign Application Priority Data
Nov. 26, 2009 (SG) 200907917-9

(51) Int. Cl. G06F 17/30

(52) U.S. Cl. 707/756; 707/E17.009

(57) ABSTRACT

Medical scan data, such as brain scan data, from a plurality of patients suffering from a medical condition such as a stroke is used to construct a probabilistic atlas. A first portion of the atlas indicates, for each location, the corresponding likelihood of a medical abnormality (such as a lesion) associated with the medical condition being present at that location. A second portion of the atlas includes, for each location and each of one or more parameters, corresponding parameter data indicative of the values taken by the parameter for those patients suffering from the medical abnormality at the corresponding location. The probabilistic map can be used to extract outcome data from a scan obtained from a new subject, such as by locating a medical abnormality within the scan of the subject, and obtaining the outcome data using the corresponding locations in the probabilistic map.

### FIELD OF THE INVENTION

The present invention relates to a method and system for using scan data from patients with a medical condition, such as a stroke, to construct a probabilistic atlas. It further relates to a method and system for using the probabilistic atlas to generate outcome data relating to a subject, that is data indicating the probability of a certain medical outcome for the subject. The scan data may be brain scan data, but may alternatively relate to any other organ such as a liver, a lung, a heart or prostate.

### BACKGROUND OF THE INVENTION

It is known to use data obtained from a plurality of patients suffering from a certain medical condition to make predictions concerning a subject suffering from the same condition, e.g. a prediction of whether that subject will survive. Normally, these techniques employ parameters which are believed to be correlated with prognosis of the medical condition. The parameters are measured for each of the patients (“parameter data”), and for each patient we also obtain outcome data describing an outcome for each patient. The parameter data and outcome data are used to generate a prediction engine, e.g. one using a multiple regression equation. Parameter data describing the subject is then input to the prediction engine, and the prediction engine generates outcome data which predicts an outcome for the subject. There are many possibilities for what the outcome data may describe. In various pieces of research the outcome data has described the length of survival, the length the subject had to stay in hospital, the outcome of intravenous and intra-arterial thrombolysis in acute ischemic strokes, the long term outcome, or the probability of survival at any instant.

For example, in [4] the outcome data described the probability P of mortality, which was assumed to be according to the equation:

$$P = \frac{{e}^{f ( X )}}{1 + {e}^{f ( X )}} \qquad ( 1 )$$

where

f(X)=c+ΣᵢaᵢXᵢ (2)

c is a constant, {Xᵢ} are the values of a set of significant parameters, and {aᵢ} are a set of coefficients produced by multinomial logistic regression fit to the data for the patients.

Another example is to predict probability of survival at any particular instant of time based on the Cox proportional hazard model [5]

$$ln ( \frac{H ( t )}{{H}_{0} ( t )} ) = {\sum }_{i} {b}_{i} {X}_{i} \qquad ( 3 )$$

where

$$( \frac{H ( t )}{{H}_{0} ( t )} )$$

is called the hazard ratio, H(t) is called the hazard function, and H₀(t) is a baseline hazard at a time t when the value of all the predictors {Xᵢ} are equal to 0. Then, the survival curve is as follows

S(t)=exp(−H(t)) (4)

Such techniques have previously been used for predicting outcomes for patients suffering from strokes [6]. However, it is disadvantageous that they do not take into account brain scan data for the patients and the new subject, even though brain scans are known to be a very powerful tool for decision making when handling stroke patients.

### SUMMARY OF THE INVENTION

The present invention aims to provide a methodology for using medical scan data, such as brain scan data, and other data, relating to many patients suffering from a medical condition, to generate a data structure which can be used to obtain information in relation to a new subject suffering from the condition.

The present invention proposes in general terms that scan data from a plurality of patients suffering from a medical condition is used to construct a probabilistic atlas. A first portion of the atlas indicates, for each location, the corresponding likelihood of a medical abnormality (such as a lesion) associated with the medical condition being present at that location. A second portion of the atlas includes, for each location and each of one or more parameters, corresponding parameter data indicative of the values taken by the parameter for those patients suffering from the medical abnormality at the corresponding location.

The probabilistic atlas makes it possible to use parameter data for a subject to predict locations of the medical abnormality in the subject (e.g. if no scan for that subject is yet available), and/or to use scan data for the subject to predict parameter values for the subject.

The medical condition may be a stroke, in which case the probabilistic atlas is referred to as a “Probabilistic Stroke Atlas” (PSA). The scan data may be brain scans.

The probabilistic atlas can be presented in an image format. This allows the probabilistic atlas to be image processed, analyzed, and visualized. It can also be used to extract knowledge. For example, a PSA can be used to support stroke diagnosis, treatment and prediction as well as to extract knowledge about the stroke.

For example, a brain scan can be obtained from a new subject, the location of the medical abnormality within the scan can be identified, and then, by comparing this location to the corresponding parts of the probabilistic map, information (such as prognosis probability) specific to the subject can be extracted.

In one form of the invention, data generated using the probabilistic map and scan data and/or parameter data for the subject, is input to a prediction engine, which generates output data for the subject.

### BRIEF DESCRIPTION OF THE FIGURES

An embodiment of the invention will now be described for the sake of example only with reference to the following figures in which:

FIG. 1 is a flow diagram of a method according to an embodiment of the invention for constructing a PSA in an embodiment of the invention;

FIG. 2 is a schematic view of a PSA constructed by the method of FIG. 1;

FIG. 3 indicates one possibility for performing a step of the method of FIG. 1;

FIG. 4 is a flow diagram showing a method according to an embodiment of the invention for using the PSA of FIG. 1 for obtaining information relating to a new subject;

FIG. 5 shows schematically a step of the method of FIG. 3;

FIG. 6 is a structure for performing two steps of the method of FIG. 4;

FIG. 7 is experimental data obtained from an implementation of the invention, and overlaid by a lesion contour for a subject; and

FIG. 8 shows schematically a process which is another embodiment of the invention, and combines a method according to FIG. 3 with a feedback step using the method of FIG. 1.

### DETAILED DESCRIPTION OF THE EMBODIMENTS

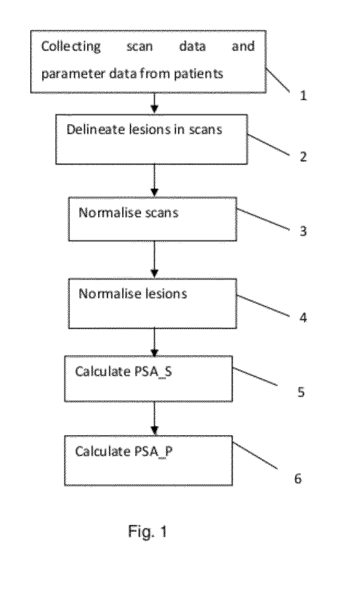

A method which is an embodiment of the invention, for obtaining a probabilistic stroke atlas is illustrated in FIG. 1.

The starting point of the method (step 1) is collecting a data set from a plurality of patients suffering from a stroke. The patients will usually be human subjects, though in principle they could instead be animals. The data set includes volumetric images (three-dimensional brain scans) for each of the patients. The scans may be any tomographic scans, such as Computed Tomography (CT) scans, Magnetic Resonance Imaging (MRI) scans, or Positron Emission Tomography (PET) scans. Step 1 may include generating these scans, or obtaining them from an external source.

In addition, step 1 includes collecting “parameter data”, that is data which for each of the patients characterizes a set of N parameters for the patient. The parameters are labeled by an integer variable n which runs from 1 to N. The parameters may be any patient-specific data, including demographic data, history data, clinical data, ambulatory data, data describing drugs taken, blood biomarkers data, hospitalization data, and outcome data. For example, the list of parameters may include any the parameters set out in Tables 1, 2 and 3, all of which are known to be significant variables in the prediction of mortality from strokes. The parameter data for these parameters is numerical. For example, when the parameter has two possibilities (e.g. the parameter “sex”), one of the possibilities is given a numerical value 1 and the other 0. The parameters in Table 2 are whether specific drugs or types of drugs have been administered to the corresponding patient during hospitalization. The parameters in Table 3 are outcome variables. The modified Rankin Scale (mRS) is a commonly used scale for measuring the degree of disability or dependence in the daily activities of people who have suffered a stroke. The scale runs from 0 (no symptoms) to 6 (death). The parameters presented in the tables are only an example. There can be additional parameters and outcomes (e.g. length of stay in hospital) related to the patient.

TABLE 1
significant variables in prediction of mortality

Sex
Age
History of diabetes mellitus
Intensive Care during first 24 hrs from hospitalization
Epilepsy attack during first 24 hrs from hospitalization
Infection during first 24 hrs from hospitalization
Heart failure during first 24 hrs from hospitalization
Infection during hospitalization
Intensive Care during hospitalization
White blood cells
Red blood cells
Hemoglobin
Hematocrit
Lymphocyte percentage
Red cell distribution width
Glucose value - emergency department
Sodium value - emergency department
Urea - emergency department
Creatinine - emergency department
Fibrogen
D-dimers
Cholesterol
Low density lipoprotein
Fasting glucose
Free triiodothyronine
C - reactive protein
Diuretics
Width of red blood cell distribution
Time from the disease's beginning to the admission to
hospital (hours)
Heart rate - admission
National Institutes of Health Stroke Scale NIHSS - at
admission
National Institutes of Health Stroke Scale - 7th day
Temperature - 7th day of stroke
Heart rate - 7th day
Six Simple Variables - 7th day of stroke
Barthel Index - 30 days after stroke
Glasgow Outcome Scale - 7th day after stroke
Glasgow Coma Scale - admission
Range of stroke
Etiology of ischemic stroke

TABLE 2
drugs given during hospitalisation

Simvastatin (given during hospitalization)
Subcutaneous - heparin (given during hospitalization)
Oral - warfarin (given during hospitalization)
Pentoxifylline (given during hospitalization)
Calcium channel blockers (given during hospitalization)
Steroids (given during hospitalization)
Antibiotics (given during hospitalization)

TABLE 3
outcome variables

Modified RANKIN scale - 7th day of the stroke
Modified RANKIN scale - 30 days after stroke
Modified RANKIN scale - 90 days after stroke
Modified RANKIN scale - 180 days after stroke
Modified RANKIN scale - 360 days after stroke
Barthel 30 days
Barthel 90 days
Barthel 180 days
Barthel 360 days

Optionally, for one or more of the patients, the data set may include scan data and corresponding parameter data describing the patient at a number of times K where K is an integer greater than one. These times are labeled by an integer variable k=1, . . . K. One way of defining the K times is based on a respective set of times after a starting point such as the respective onset of the stroke. For example, the scan data and parameter data may be collected for some or all patients K=3 times, e.g. 7 days, 30 days and 90 days after the onset of the stroke.

Alternatively, the data set may not be generated at exactly these times. Instead, we may define K “bins” (that is non-overlapping time ranges measured from the starting point), such that data relating to a given one of the patients is allocated to one of the bins if it describes a patient at a time which is within the corresponding time range.

In another alternative, the K “times” may not be defined by chronological time, but instead by stages of the medical condition (e.g. stroke stages). For instance, k=1 may be defined as a time before stroke occurrence. k=2 may be defined as the time of a primary stroke. k=3 may be defined as the time of a secondary stroke, and so on.

The data set may contain a number of gaps (i.e. missing elements of data). For example, for some patients there will be no scan data available describing times before the stroke onset. In this case, the values of PSA are calculated, for instance, as the averages over the patients for which data is available.

Note that the parameters will typically not depend upon k. For some parameters, this is because their value is intrinsically constant (e.g. “sex” is constant). For others, the parameter is defined at a specific time, such as the time of admission/hospitalization. Thus, for example, if the n-th parameter is 1 if a certain drug has been administered and zero otherwise, this means whether the drug had been administered by the time of admission/hospitalization, not whether it had been administered at time k. So, the value of PSA_P_{k,n} is calculated over all scans for time k, but only for patients to whom the drug had been administered by the time of admission/hospitalization.

In possible variations of the embodiment, some of the parameters are defined such that the parameter values can change. One way of doing this would be to define k parameters, each indicating whether something has happened by the corresponding time k (e.g. whether a drug had been administered, or the development of some disease such as diabetes/heart disease, etc).

For each patient, and for each of the K times, the data is processed independently, by performing steps 2-4. In step 2, a lesion (e.g. infarct) in one of the brain scans is delineated (e.g., “contoured”, which is to say that a contour is drawn around its outline) by applying a manual or automatic approach, for instance, that presented in [1]. Then in step 3, the scan is normalized to a common space (the “atlas space”) using any brain warping technique, for instance, the Fast Talairach transformation [2] or an ellipse-based fitting method [3]. In step 4, the data defining the delineation of the lesion is normalized in the same way. Thus, we have transformed the original data to data in the common space describing the locations of points exhibiting the medical abnormality (i.e. the lesion).

Note that there is some flexibility in the order in which these steps are performed. For example, step 3 may be performed before step 2. Also, for a given patient, steps 2-4 may be performed for all the K times, before going on to the next patient; alternatively, the method could perform steps 2-4 for k=1 for all patients, and then perform steps 2-4 for k=2 for all patients, and so on.

In steps 5 and 6, the PSA is generated. The PSA includes two components: PSA_S (the “scan part”) and PSA_P (the “parameter part”). Each of the PSA_S and PSA_P is composed of three-dimensional (3D) image volumes. Furthermore, each PSA_S and PSA_P is partitioned into K parts, corresponding to the K times.

For a given acquisition time k, the PSA scan part (PSA_Sₖ) is a single volume, and the PSA parameter part is composed of N volumes (PSA_P_{k,n}, n=1 . . . N), where each volume corresponds to a single parameter. Thus, the PSA can be denoted as follows:

PSA={PSA_{—}Sₖ,{PSA_P_{k,n}}ₙ₌₁^{N}}ₖ₌₁^{K} (5)

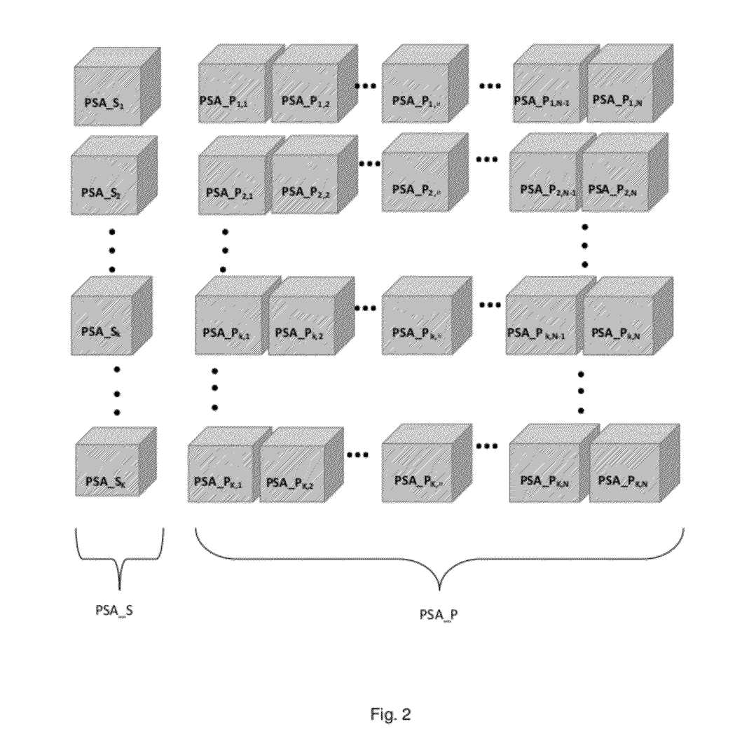

The PSA can be considered as matrix of component volumes, as shown in FIG. 2. The number of rows and columns of this matrix are K and N+1, respectively. Each of the cubes represents a numerical function defined at each location in the 3D atlas space. In other words, each of the numerical functions is “volumetric”. In practice, the common space is discrete, so that each “location” corresponds to a voxel of the common space.

Preferably, the parameters are chosen so as to be statistically independent. Initially, for example, when it is decided to apply the invention to a certain medical condition, a number of parameters Ñ may be considered which is greater than N, and a screening step may be performed to extract from the set of subset of N parameters which are statistically independent. This would remove a potential problem which may exist in certain aspects of the invention that the parameters exhibit co-linearity (or multi-co-linearity). The potential problem of co-linearity may be illustrated by supposing that two parameters are highly correlated. In this case, allowing a prediction to be influenced by both of them might be equivalent to giving one of them a too high prominence in making the prediction.

PSA_S is calculated in step 5. It is composed of K frequency functions (or “atlas functions”) PSA_Sₖ for k=1, . . . , K. Each PSA_Sₖ takes a single value for each of point of the common space (atlas space). Each PSA_Sₖ is calculated using only images for the corresponding value of k. The value PSA_Sₖ at each location in the atlas space is obtained from the normalized lesion outlines (that is, 3-dimensional surfaces (“contours”) surrounding volumes) of the brain scans with the corresponding value of k. Specifically, for any given location in the common space, the value of PSA_Sₖ is equal to the number of patients whose brain scans for the corresponding value of k have normalized contours (lesions) which encompass this location. The atlas function can optionally be normalized (for instance, by dividing it by the total number of brain scans for that value of k) to represent atlas probability.

PSA_P is calculated in step 6. It is composed of K×N frequency functions PSA_P_{k,n} for k=1, . . . , K and n=1, . . . , N. Again, each PSA_P_{k,n} takes a single value for each of location of the common space (atlas space), and each PSA_P_{k,n} is calculated using only brain scans for the corresponding value of k. The value PSA_P_{k,n} at any location in the atlas space is computed by finding a data value which is indicative (as defined below) of the values taken the n-th parameter over those patients having a lesion encompassing that location, and normalizing this value by PSA_S for the same location. The indicative data value may be an average value. In other words, each PSA_P_{k,n} in each location may be the average value of parameter n for those patients who at time k had a lesion encompassing this location. The “average” may be a mean value. Alternatively, the indicative data value may be another type of average, such as a median. Alternatively, the indicative data value may be any other value derived from values for parameter n for those patients who at time k had a lesion encompassing this location, such as the minimum/maximum value of the parameter, or any percentile of the distribution of the parameter over those patients.

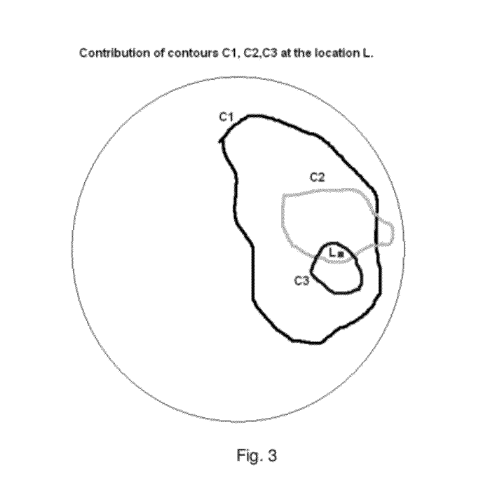

Steps 5 and 6 may employ some additional information, for instance the distances to the PSA lesions or the size of patient's lesion and/or the shape and/or pattern of lesion. This possibility may apply to the calculation of either or both of PSA_S and PSA_P. It is illustrated using FIG. 3. While calculating the mean values at a particular location, we assign more weights to the smaller lesions at this location. This is because the local contours (i.e. having smaller volumes) around a particular location are more informative about that location, for example they represent closer values of each parameter than far away locations. For example, referring to FIG. 3, all points within the contour C3 are fairly close to L, and may be expected to have generally similar values of each of the parameters, whereas the contour C1 also includes locations very far from L which may have significantly different values for some parameters. Priority can be given to local contours around a particular location in several ways. For example, the effect on location L from far away locations may be reduced by calculating PSA_P for a given point and for a given parameter as a weighted mean, as follows:

$$\frac{{\sum }_{i}^{ } {w}_{i} {p}_{i}}{{\sum }_{i}^{ } {w}_{i}} , \qquad ( 6 )$$

where pᵢ indicates the value of the given parameter for a patient i whose lesion includes the corresponding location, and wᵢ is higher for smaller contours. wᵢ may for example be defined as 1/(three-dimensional volume surrounded by the contour), or any other expression which gives priority to local regions around L. The weighting may also include priority of directions (e.g. posterior to inferior, left to right or inferior to superior) as well as underlying anatomy taken from the standard brain atlas.

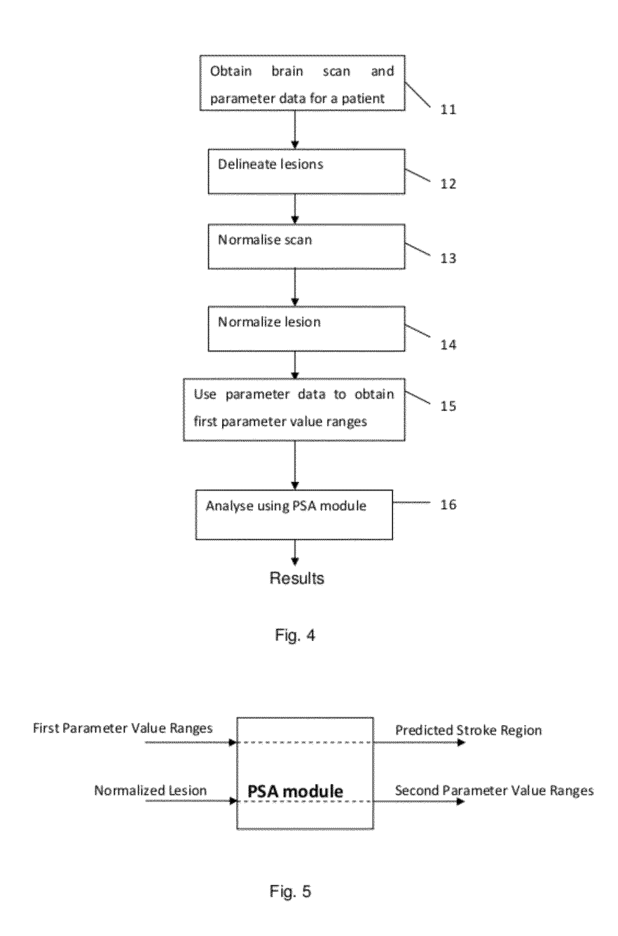

FIG. 4 illustrates a method which is an embodiment of the invention, to use the PSA to obtain information in relation to a person referred to as a “subject”. In a first step 11, a brain scan for the patient is received (e.g. generated), and so is parameter data describing the subject in terms of the parameters. Note that in some cases this data may not be produced for all N of the parameters, since the acquisition may be costly and/or time consuming.

In step 12, a lesion in the subject's brain scan is delineated, e.g. using the methods of [2] or [3]. In step 13, the scan is normalized into the atlas space (common space), and in step 14 the delineated lesion is normalized into the atlas space. The techniques for normalization of the subject's data are the same as those used in steps 3 and 4 of FIG. 1.

In step 15, the parameter data is used to generate first parameter value ranges. The first parameter value ranges are ranges centred on the parameter value given by the subject's parameter data. They are different for each parameter and have a width of 2Δₙ, where Δₙ may be related to the error bars on the measurement of parameters.

In step 16, the first parameter value ranges and delineated lesion are input to a PSA module which performs volumetric analysis, diagnosis, and prediction using the PSA generated by the method of FIG. 1, to generate results describing the subject. This analysis may be enhanced with standard brain atlases with anatomy, vasculature, and blood supply territories, by providing additional information from anatomy, vessels and their supply and drainage regions, tracts (that is, systems of organs and tissues which perform a specialist function) which are modified in a treatment, and/or large vessels that are crucial to treatment. These atlases can be mapped onto the scan data, and included in the database.

The operation of a PSA module which performs step 15 is shown schematically in FIG. 5. The PSA module receives the normalized lesion. It also receives the first parameter value ranges. The process of FIG. 5 uses only the part of the PSA which has the same k-value as the k-value for the subject.

Upon receiving a contour representing the subject's lesion, the PSA module uses PSA_P to output second parameter value ranges (that is, numerical values indicative of the second parameter value ranges) describing the respective distributions of each of the respective N parameters. The second parameter value range for parameter n for the subject at time k is found by extracting from the PSA the value of PSA_P_{k,n} for each location in the subject's lesion, and then working out the distribution of those values.

For each parameter for which data describing the subject is received in step 11, upon receiving the corresponding first parameter value range, the PSA module uses PSA_P to output a corresponding brain region, meaning a volume in the brain which is a potential location of a stroke. This is called a “parameter region”. The parameter region is the set of locations for which PSA_P_{k,n} is within the corresponding first parameter value range. Thus, if in step 11 data was received for all N parameters, the PSA module generates N parameter regions corresponding to each of the N parameters. The PSA module then uses the generated parameter regions and the PSA_S to produce a predicted stroke region.

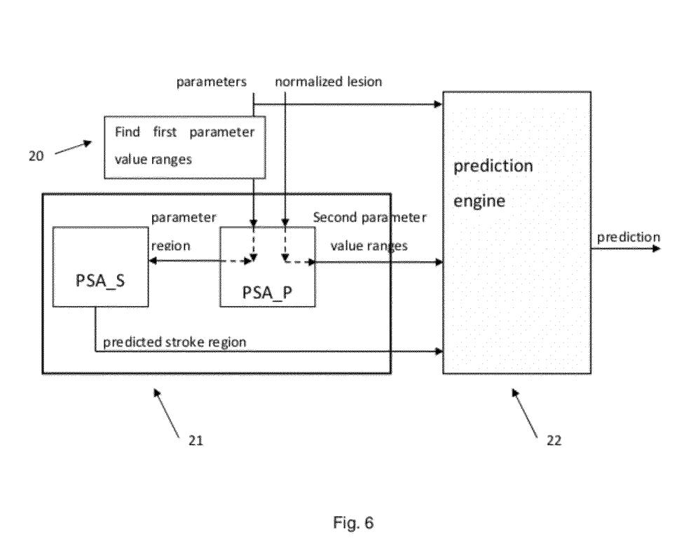

FIG. 6 illustrates a structure including a module 20 which performs step 15, and a PSA module which performs step 16. The PSA module is shown in FIG. 6 as having two components: a first module 21 for generating the second parameter value ranges and a predicted stroke region, and a prediction engine 22. As shown in FIG. 6, when the first parameter value ranges obtained from the subject's parameter data are input into the PSA module, the output is respective parameter regions. These parameter regions, and the PSA_S are used to produce a probability distribution indicating the likelihood of each point in the atlas space being part of the subject's lesion. Specifically, for each parameter for which data was received in step 11, the corresponding PSA_P_{k,n} is used to generate a corresponding parameter region. This is the region of the common space for which the first parameter value range includes the corresponding value of PSA_P_{k,n}. The parameter regions are combined by some operator, for instance AND or OR, to form a “predicted stroke region”. Either the AND or OR operator can be applied first. The PSA_S may be used to control how the parameter regions are combined (for example, by using to PSA_S to determine which of the OR or AND operations is performed).

As explained, the parameter regions are obtained from the earlier subjects, e.g. when the earlier subjects had a particular combination of the parameter values (which is similar to the subject), certain stroke regions in the scans were observed for those patients. Combining the parameter regions using the OR operation would produce all possible regions observed (but also false positive regions), whereas the AND operation would produce the overlapping regions (where most probable regions could be located depending on the frequency of occurrence of regions at a particular location). Both operations could be applied to get an idea of least probable or the most probable regions. The combination of parameter regions from the PSA_P is performed by PSA_S.

Note that in principle there are other ways of producing a predicted stroke region from the parameter regions without using the PSA_S, such as measuring whether any given voxel was inside more than half of the parameter regions, and taking the predicted stroke region as those voxels which are within most of the parameter regions. However, use of the PSA_S is preferred. The way in which the PSA_S is used to combine the parameter regions may employ information from probabilistic neural networks or regression models, which would be optimized for accuracy.

As seen from FIG. 2, PSA_S is the combination of scans. So if we are only interested in predicting what happens to patients, with lesions only in the hippocampus region, with a certain volume and shape, only the PSA_S part would typically be helpful in this case, as the scan information is only in PSA_S.

The predicted stroke region is then input to the prediction engine 22.

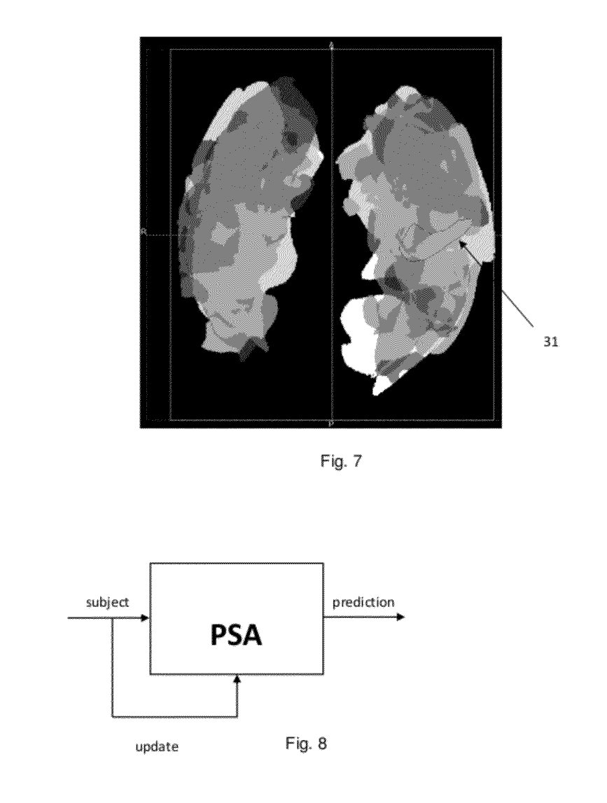

The predicted stroke region may be additionally processed, e.g. by the prediction engine 22. For example, this can be done by finding the associated actual outcome of the patients corresponding to the contours (an example is discussed below with reference to FIG. 7). Using PSA_S, depending on the number of cases used to generate the PSA, multiple compact regions may be produced. Additional criteria used to remove false positives may be applied. All these regions can then be used to predict the associated outcome. Predicted stroke regions would be helpful in case the stroke is not visible on a subject's scan e.g. during first few hours after a stroke.

The second input to the first module 21 is a “normalized lesion” which is in the form of a region. The PSA_P generates second parameter value ranges for each parameter. These second parameter value ranges are expressed by numerical values. The numerical values may be in the form of first order statistics such as range, minimum and maximal values, or mean. The numerical values are input into the prediction engine 22.

Thus, as shown in FIG. 6, the data input to the prediction engine 12 comprises both the second parameter value ranges and the predicted stroke region. Typically, the unit 21 performs a process of using the predicted stroke region to extract a number of variables characterizing the predicted stroke region (e.g. the volume of the lesion, location of centre, direction of principle axis, texture of the lesion, shape of the lesion, and/or exact voxel information with a prediction equation at each voxel, e.g. a logistic regression equation), and it is these variables which are input into the prediction engine 22.

Note that optionally (and as shown in FIG. 6) the prediction engine 22 additionally receives the parameter data from the subject obtained in step 11.

As mentioned above, it is possible that in step 11 data was not collected from the subject for all N parameters. If so, the module 21 may also predict the missing parameters, e.g. as an average over the subject's lesion contour of the corresponding PSA_P_{k,n}. The resultant values may then be used to produce corresponding parameter regions to help produce the predicted stroke region and/or for input to the prediction engine 22.

The output from the prediction engine 22 is outcome data describing the patient, e.g. predicting survival, outcome (measured in stroke scales), hospital stay, etc. Also, the prediction engine 22 may output a selected one of a set of pre-generated time evolution curves, e.g. curves illustrating the evolution of penumbra at particular locations.

The prediction engine 22 can be generated using the known techniques [4, 5] described above. The prediction engine may for example be generated using regression models based on outcome data for the patients. It may employ an equation, e.g. a multivariate regression model, which can input the parameter data from the patients, and the data generated by the first module 21 when presented with the data set relating to the patients, and use them to make a prediction of a particular outcome. An experimental demonstration of the use of the technique has been performed in which data from about 150 ischemic lesions was used to predict outcomes, such as modified RANKIN scales and mortality. The prediction rate was found to be approximately 95%.

Note that there are other possible uses of the PSA, apart from generating inputs to a prediction engine. Any volumetric atlas component can also be inspected visually (see the discussion of FIG. 7, below). Some image processing, visualization, and manipulation operations can be applied to these volumes. For instance, thresholding can facilitate selection of sub-volumes in certain ranges, and eliminate regions with low probabilities or which were caused by small number of the patients. Also the predicted stroke regions could assist the clinicians in providing the ROI and the related outcome using only the patient parameters.

Additionally, the predicted stroke region is itself of interest, since often in the first hours after a stroke, it is not logistically possible to perform a scan, so the predicted stroke region provides an alternative.

The PSA in addition provides a range of actual outcome of previous patients having lesions in the same locations as the current patient. This is because the set of parameters includes the outcome parameters shown in Table 3. These two predictions could be combined to provide “best and worst scenario” of outcome from actual cohort of previous patients in addition to the outcome predicted by the predictive engine 22.

In one example, patient parameters (for example, Age=55; NIHSS=15, sex=female) are input to the first module 21 and the prediction engine 22. The prediction engine then uses a model equation (for example [4]) to predict the probability of survival of the patient within a year (the actual value of this may be 80% for example). At the same time, the first module 21 uses PSA_P and the normalized lesion of the patient to derive the median and inter-quartile range of fraction of actual previous patients who had a lesion in the same location as the current patient and survived (for example, the 25^{th} percentile of fraction of actual previous patients who survived may be 72% whereas the 75^{th} percentile may be 85%). Thus, the theoretical model results (for example the model equation [4]) can be combined with the actual scenario (the fraction of actual previous patients who survived). The prediction the first module 21 makes using the PSA_S provides lesion region predictions (“predicted stroke regions” in FIG. 6) from the parameters describing the subject.

The prediction engine 22 takes into account the scan and parameters for the actual patient and those for the population of preciously treated patients. The prediction engine comprises two categories of inputs: (i) Actual spatial region/parameters (ii) Predicted spatial region/parameters. While actual parameters/region could be used to predict the probability of any outcome for a specific subject (e.g. from a prediction model), the predicted parameters/regions could provide a distribution/best and worst scenario from the actual cohort. Thus the prediction combines a model based approach to a something like a “probabilistic neural network approach” [7], where a nearest possible scenario is searched for. This combination enhances the accuracy and confidence of prediction.

Consider a simple example. Let us use as the parameter n, the Modified Rankin Scale (mRS). At the time k corresponding to the 30^{th} day, PSA_P_{k,n} can be denoted by PSA_mRS30. A 2-D slice through this 3-D volume is illustrated in FIG. 7.

FIG. 7 also indicates by 31 a line which is the projection into the 2-D slice of a contour which is the outline of a delineated lesion for a certain subject. The contour 31 is overlaid on the PSA_mRS30. Within the contour, PSA_mRS30 takes values in the range 4-6, so this provides a range of values which are believed to apply to the subject. In fact for this subject, the actual mRS value on the 30^{th} day was 5.

Note that the PSA_S is an important part of the embodiment, and useful even apart from the PSA. The reason is that all the contours are stored in the PSA_S. Even without any parameters, if the doctor is interested in knowing the outcome of a patient with the lesion at a particular location, he can directly use the PSA_S part of the prediction engine.

Many variations of the embodiments described above are possible within the scope of the invention. For example, in a variant of the method of FIG. 4, step 11 could omit obtaining a brain scan for a patient, so that steps 13 and 14 would also be omitted. Instead, the just parameter data for the patient could be used with the PSA_P to generate parameter regions as described above, and from these a predicted stroke region, would be produced as described above. This predicted stroke region could then be used in FIG. 6 in place of the normalized lesion.

The PSA can be updated dynamically. This is illustrated schematically in FIG. 8. Here data concerning a new subject (e.g. the brain scan and parameter data collected in step 11) is processed to output results (e.g. by a method as shown in FIG. 3), but also used to update the PSA (e.g. by repeating the method of FIG. 1 treating the subject as an additional one of the patients).

In summary, the PSA is a tool for aggregating data and knowledge from previous patients. It includes a matrix of 3D volumes, and each of them can be processed, analyzed, and visualized, and knowledge can be extracted from them. This is a dynamic atlas, which can be updated with newly processed cases. Since the PSA is composed of numerous components, it is preferable to use a prediction engine to process data generated using the PSA.

The use of the PSA was discussed and illustrated in the context of strokes, but this type of atlas can be used to handle any pathological cases, for instance, brain tumors or hematomas. It can be applied to a spectrum of problems to monitor staging, evaluation, and progress treatment effectiveness. Furthermore, the scan data need not be brain scan data, but may alternatively relate to any other organ such as a liver, a lung, a heart or prostate, and any medical condition in which scan data and clinical data are available.

### REFERENCES

[1] Bhanu Prakash K N, Gupta V, Nowinski W L: Segmenting infarct in diffusion weighted imaging volumes. BIL/Z/04381, BIL/P/04381/00/PCT, PCT/SG2006/000292, filed 3 Oct. 2006. (former title: Segmentation and identification of infarcts and artifacts in diffusion weighted volumes using energy measures)
[2] Nowinski W L, Qian G, Bhanu Prakash K N, Hu Q, Aziz A: Fast Talairach Transformation for magnetic resonance neuroimages. Journal of Computer Assisted Tomography 2006; 30(4):629-41.
[3] Volkau I, Bhanu Prakash K N, Ng T T, Gupta V, Nowinski W L: Registering brain images by aligning reference ellipses. BIL/Z/04234, BIUP/04287/00/US, Provisional application No. 60/839,711 filed on 24 Aug. 2006. SG patent no. 148531 granted on 30 Sep. 2009.
[4] Freedman DA: Statistics Models: Theory and Practice. Cambridge University Press, New York, 2005.
[5] Therneau T M, Grambsch P M: Modeling Survival Data: extending the Cox Model. Springer Verlag, New York, 2000.
[6] Kent D M, Selker H P, Ruthazer R, Blumki E, Hacke W: “The Stroke-Thrombolytic Predictive Instrument: A predictive instrument for intravenous thrombolysis in acute ischemic stroke”. Stroke 2006, 37:2957-2962.
[7] Specht D F. Probabilistic neural networks. Neural Networks 1990, 3(1):109-118.

1. A method of generating an atlas database from a plurality of volumetric images, each volumetric image being associated with a set of parameters (n=1, . . . N) and including a set of locations associated with a medical abnormality, the method comprising:
transforming said locations to transformed locations in a common space;
generating a first segment (PSA_S) of the database as a plurality of data values corresponding to respective points in the common space, each said data value being indicative of the number of said volumetric images for which one of the corresponding transformed locations is at that point in the common space;
for each of the parameters, generating a corresponding second segment of the database (PSA_Pₙ) as a plurality of data values corresponding to respective locations in the common space, each said data value being indicative of the parameter, and each said data value being calculated over those volumetric images for which one of the corresponding transformed locations is at that location in the common space.

2. A method according to claim 1 in which said data value of each parameter is a weighted mean value, wherein higher weights are associated with ones of the volumetric images for which the transformed locations span a smaller portion of the common space.

3. A method according to claim 1 wherein there is a respective said plurality of volumetric images for each of a set of K time samples (k=1, . . . K), and, for each said plurality of volumetric images, the method includes generating a respective said first segment of the database (PSA_Sₖ), and for each parameter a respective said second segment of the database (PSA_P_{k,n}).

4. A method of analyzing a subject's volumetric image using an atlas database having:
a first segment (PSA_S) which is a plurality of data values corresponding to respective points in a common space;
for each of a set of parameters (n=1, . . . N), a corresponding second segment of the database (PSA_Pₙ) which is a plurality of data values corresponding to respective locations in the common space;
the method comprising:
identifying, in the common space, a set of locations in the subject's volumetric image associated with a medical abnormality;
for each of the parameters, obtaining one or more numerical values characterizing the data values within a portion of the corresponding second segment of the database, said portion of the corresponding second segment of the database corresponding to the identified set of locations in the subject's volumetric image; and
using the numerical values to obtain outcome data indicating a predicted outcome for the subject.

5. A method according to claim 4 in which the obtained numerical values are used inputting the obtained one or more numerical values into a prediction engine to obtain the outcome data as an output of the prediction engine.

6. A method according to claim 5 further including, for one or more of the parameters, inputting to the prediction engine values of the parameter obtained from the subject.

7. A method according to claim 5 in which said one or more numerical values for each parameter characterize the distribution of the corresponding parameter in said portion of the corresponding second segment of the database.

8. A method according to claim 4 further including using one or more of the second segments of the database to obtain corresponding parameter regions of the common space, combining the parameter regions to form an aggregate region, using the first segment of the database to extract a data value for each point of the aggregate region, and inputting the obtained extracted data values for each point of the aggregate region, and/or data obtained from the extracted data values, into the prediction engine.

9. A method according to claim 8 in which the aggregate region is formed by an AND or OR operation performed on the obtained parameter regions of the common space.

10. A method according to claim 1 in which the abnormality is a lesion, an infarct, a brain tumor or a hemotoma.

11. A method according to claim 1 in which the volumetric images are brain scan images, and the atlas database is a brain atlas database.

12. A computer system having a processor arranged to generate an atlas database from a plurality of volumetric images, each volumetric image being associated with a set of parameters (n=1, . . . N) and including a set of locations associated with a medical abnormality, the computer system having a computer processor and a data storage device storing data processing instructions operative by the computer processor to cause the computer processor to perform:
transforming said locations to transformed locations in common space;
generating a first segment (PSA_S) of the database as a plurality of data values corresponding to respective points in the common space, each said data value being indicative of the number of said volumetric images for which one of the corresponding transformed locations is at that point in the common space;
for each of the parameters, generating a corresponding second segment of the database (PSA_Pₙ) as a plurality of data values corresponding to respective locations in the common space, each said data value being indicative of the parameter, and each said data value being calculated over those volumetric images for which one of the corresponding transformed locations is at that location in the common space.

13. (canceled)
